(19) United States
(12) Patent Application Publication
(10) Pub. No.: US 2024/0112112 A1
(43) Pub. Date: Apr. 4, 2024

(54) MEAL SHARE SYSTEM

(71) Applicant: Charles Isgar, Scottsdale, AZ (US)

(72) Inventor: Charles Isgar, Scottsdale, AZ (US)

(21) Appl. No.: 18/536,761

(22) Filed: Dec. 12, 2023

Related U.S. Application Data
(63) Continuation of application No. 16/930,663, filed on Jul. 16, 2020, now abandoned.
(60) Provisional application No. 62/874,578, filed on Jul. 16, 2019.

(51) Int. Cl. G06Q 10/0631; A23L 5/10; G06F 16/9035; G06F 16/9038; G06Q 30/0282; G06Q 30/0283

(52) U.S. Cl. CPC G06Q 10/06315; A23L 5/10; G06F 16/9035; G06F 16/9038; G06Q 30/0282; G06Q 30/0283

(57) ABSTRACT

Described is a meal sharing system. The meal sharing system includes a user computing device, a cook computing device and a server having a memory, wherein the user computing device and the cook computing device are coupled to the server through a connection established by an app operating on each of the user computing device and the cook computing device. The system allows a cook to make available for purchase or sharing a meal that the cook is preparing at home. A user desiring to eat a home-cooked meal may access the system to order the meal being prepared by the cook. The user may then pick up the meal at a location determined by the cook.

### CROSS REFERENCE TO RELATED APPLICATION[S]

This application is a continuation of U.S. patent application entitled “MEAL SHARE SYSTEM,” Ser. No. 16/930,663, filed Jul. 16, 2020 which claims priority to U.S. Provisional Patent Application entitled “MEAL SHARE SYSTEM,” Ser. No. 62/874,578, filed Jul. 16, 2019, the disclosures of which are hereby incorporated entirely herein by reference.

### BACKGROUND OF THE INVENTION

### Technical Field

This invention generally relates to a system for sharing meals, and more specifically to a system for a user to make and share meals from their home to users.

### State of the Art

There are many people that work or are otherwise busy during daytime hours and have little opportunity or little desire to prepare a home cooked meal. Often these individuals will have easy to make meals that are pre-prepared and require heating and very little cooking, or they eat out regularly or have meals delivered from restaurants. Most of these individuals at one time or another will have a desire for a home cooked meal, but still have the time constraints that make such a meal difficult to prepare. There is not a system that allows an individual to obtain a home cooked meal from another source located within a reasonable travel distance of the individual.

Accordingly, there is a need for a system that allows a person to cook extra portions of a meal and sell and/or share the extra portions of the meal with others.

### SUMMARY OF THE INVENTION

An embodiment includes a meal sharing system comprising: a user computing device; a cook computing device; and a server having a memory, wherein the user computing device and the cook computing device are coupled to the server through a connection established by an app operating on each of the user computing device and the cook computing device, and wherein the server is programmed to: receive a signal that includes meal data from the cook computing device, wherein the meal data includes cook information and meal information; automatically store the meal data in a memory of the server and make the meal data available for search and selection by a user operating the user computing device; receive a signal that includes a search request information for a meal from the user computing device; automatically process the search request information and send for display on the user computing device the meal data stored in the server, including the cook information and the meal information; receive a signal that includes a meal selection from the user computing device and automatically process the meal selection; and send a notification to the cook computing device that the meal request is a request for a meal corresponding to the meal data sent to the system with the cook computing device.

The foregoing and other features and advantages of the invention will be apparent to those of ordinary skill in the art from the following more particular description of the invention and the accompanying drawings.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 a diagrammatic view of a meal share system according to an embodiment;

FIG. 2 is a view of a programmed steps of a server of the meal share system according to an embodiment;

FIG. 3 is a view of home cooks preparing a meal for use with the meal share system in accordance with an embodiment;

FIG. 4 is a view of a man cooking a meal for use with the meal share system in accordance with an embodiment;

FIG. 5 is a perspective view of a container for use with the meal share system in accordance with an embodiment;

FIG. 6 is a perspective view of a container with portion separations for use with the meal share system in accordance with an embodiment;

FIG. 7 is a view of a user picking up a meal from a cook in accordance with an embodiment;

FIG. 8 is a front view of a computing device operating a meal share app of a meal share system to search for meals in accordance with an embodiment;

FIG. 9 is a front view of a computing device operating a meal share app of a meal share system to display pickup locations of meals on a map in accordance with an embodiment;

FIG. 10 is a front view of a computing device operating a meal share app of a meal share system to display a special event night in accordance with an embodiment;

FIG. 11 is a front view of a computing device operating a meal share app of a meal share system to display meals of the week in accordance with an embodiment;

FIG. 12 is a front view of a computing device operating a meal share app of a meal share system to rank a cook that uses the system in accordance with an embodiment; and

FIG. 13 is a view of a guest in a home that hosts a home-cooked meal in another embodiment of the meal share system.

### DETAILED DESCRIPTION OF EMBODIMENTS OF THE INVENTION

Embodiments of the present invention relate to a system for selling home cooked meal portions to buyers. The system may include the use of a mobile application operating on a user computing device that may be a mobile computing device like a smartphone, a tablet, a wearable, and the like; and/or the system may operate on any type of computing device as a downloadable application or even as a web application. The system may also include the use of programmed instructions operating on a server and communicating with the user computing device in order to provide the functionality of the system.

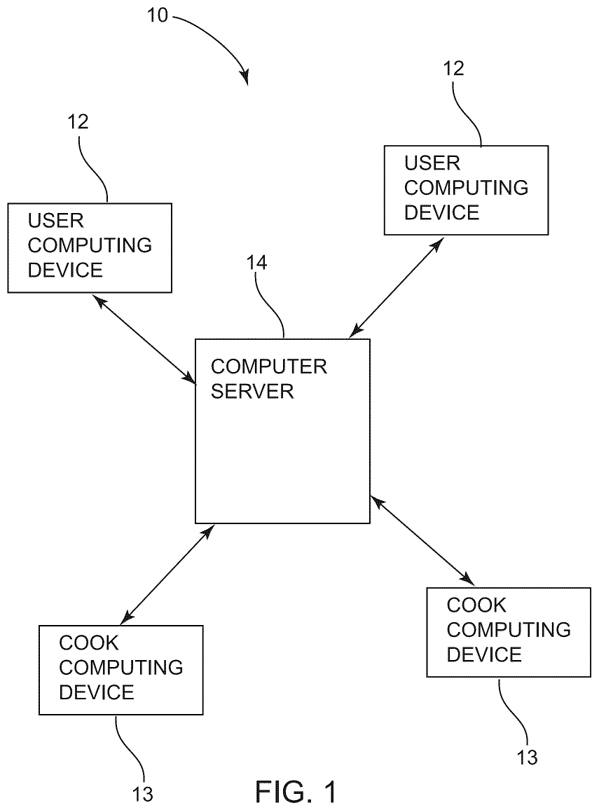

FIG. 1 depicts an embodiment of a meal sharing system 10. The system 10 may include user computing devices 12, a cook computing device 13, and a server 14, wherein each user computing device 12 and cook computing device 13 is coupled to the computer server 14. This coupling may be a network connection, such as a wireless connection through an Internet connection, a Wi-Fi connection, a Bluetooth connection or the like, wherein the user computing devices 12 and the cook computing devices 13 may communicate with and receive communication from the server 14. The user computing device 12 and the cook computing device 13 may include a desktop computer, a laptop, a tablet, a smartphone, wearable devices and the like. The server 14, in some embodiments, may be a computer server or a cloud-based infrastructure architecture.

The server 14 may include a memory storing meal data, which may further include cook information, such as demographic information of the cook, location of the cook and pickup location for meals associated with that particular cook, and meal information updated by the cook and stored on the server

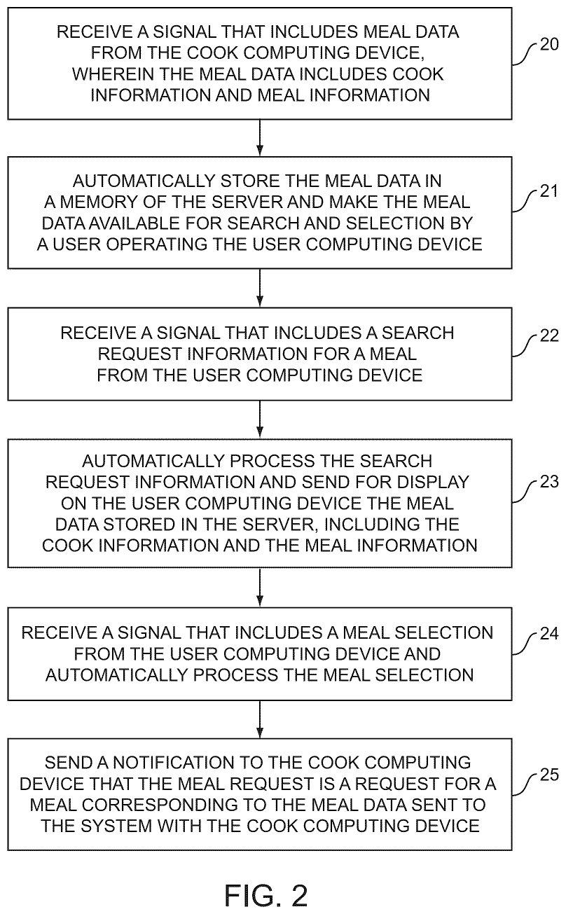

The user computing device 12 and the cook computing device 13 may be coupled to the server 14, and, referring to FIG. 2, the server 14 may be programmed to receive a signal that includes meal data from the cook computing device, wherein the meal data includes cook information and meal information (Step 20); automatically store the meal data in a memory of the server 14 and make the meal data available for search and selection by a user operating the user computing device 12 (Step 21); receive a signal that includes a search request information for a meal from the user computing device 12 (Step 22); automatically process the search request information and send for display on the user computing device the meal data stored in the server, including the cook information and the meal information (Step 23); receive a signal that includes a meal selection from the user computing device 12 and automatically process the meal selection Step 24); and send a notification to the cook computing device 13 that the meal request is a request for a meal corresponding to the meal data sent to the system 10 with the cook computing device 13 (Step 25). At this point, the cook may put the meal in a container and the user can pick up the meal at the designated location provided to the user computing device 12 by the server 14 as part of the meal data. The system 10 may include a transaction portion, wherein a stored payment system of the user may be automatically charged and provided to the cook in response to selection of the meal and/or pick-up of the meal.

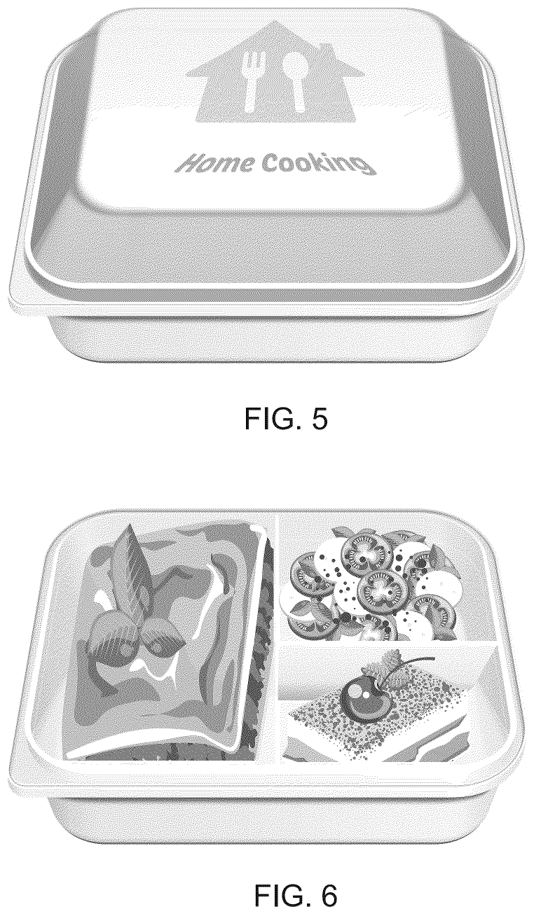

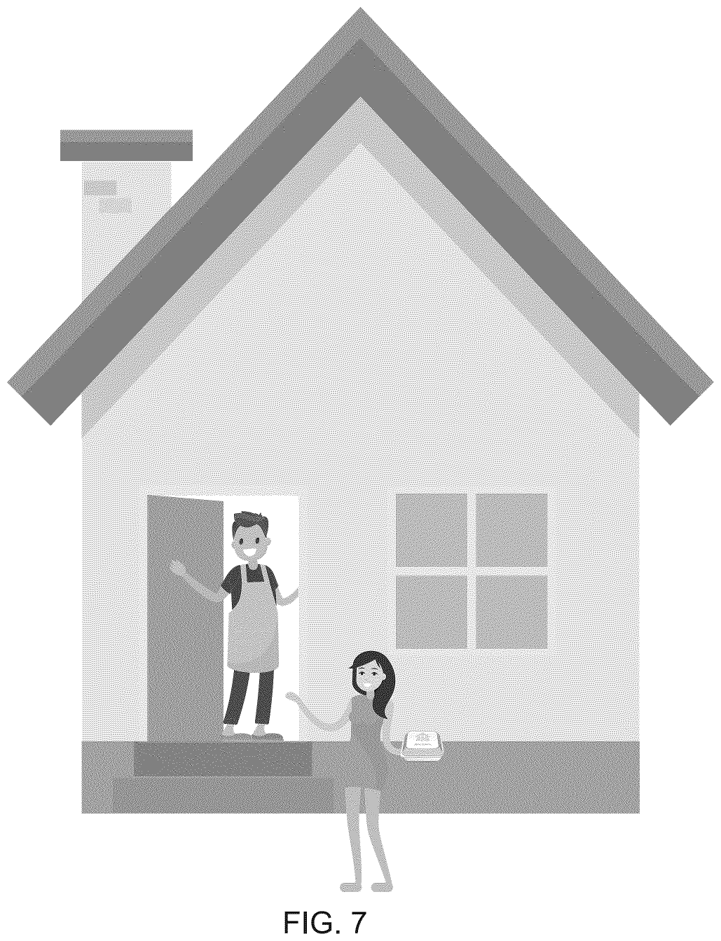

The system 10 may include standard sized containers for the meals, such as the container depicted in FIGS. 5 and 6. For example, a container may be segmented into different portion amounts for the food to be placed in (See FIG. 4). This ensures that the meals be shared/sold through the system 10 are consistent in portion sizes, thereby making the portions sizes predictable in size and predictable in cost.

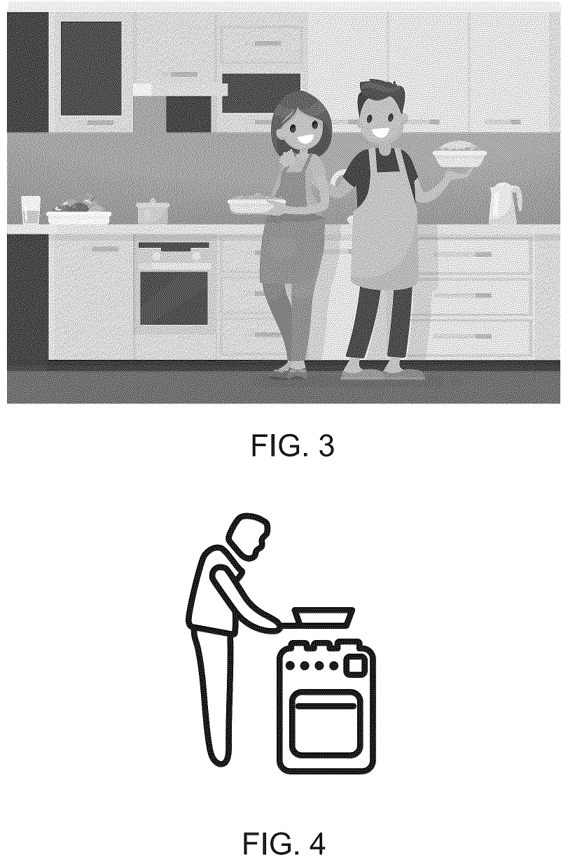

In operation, a user that is a home cook may prepare a meal that serves more than what the cook will use, as shown in FIGS. 3-4. The cook may then send meal data using the cook computing device 13 that is operating a meal share app. The meal share app creates a connection between the cook computing device 13 and the server 14. The meal data may include meal information may include the prepared meal including ingredients for each dish forming the meal, such as a main dish, a side dish, a dessert and the like. The meal data may also include a location for pickup, a time the meal will be ready for pickup, a cost associated with meal as determined by the system, and cook information, such as ratings, reviews and the like. The server 14 may receive and store meal data for a plurality of cooks.

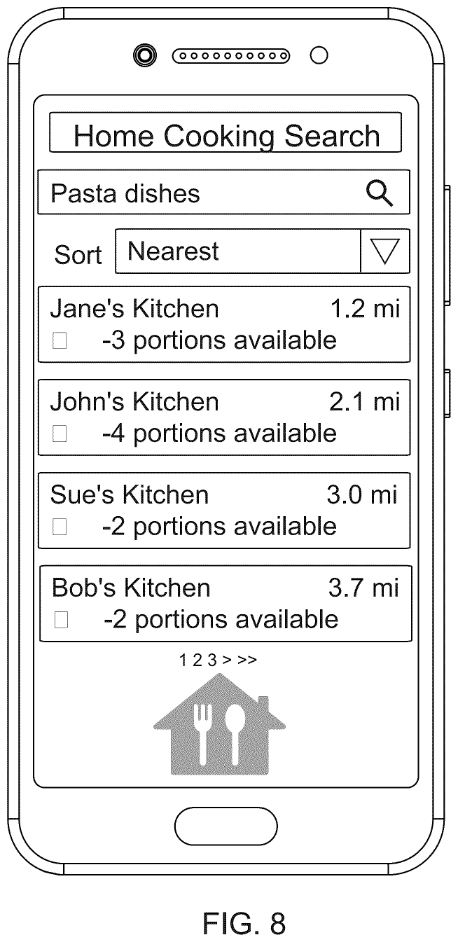

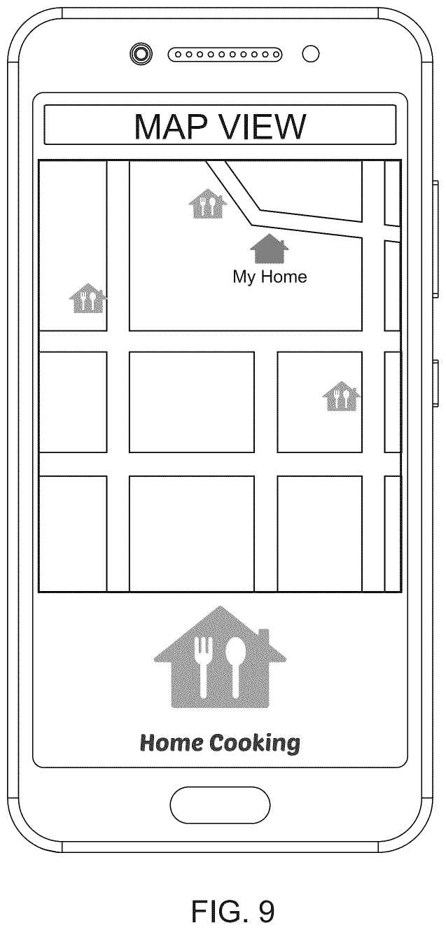

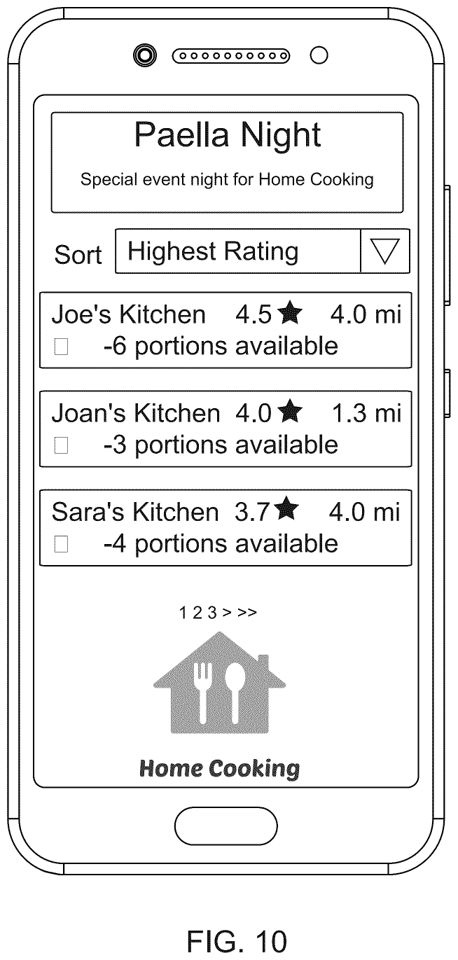

A user desiring to order and obtain a home cooked meal may access the system 10 by use of a user computing device 12 that is operating the meal share app to create a connection between the cook computing device 13 and the server 14, as shown in FIGS. 8-11. The user may search for a meal using the user computing device 12 by entering information using the meal share app. The server 14 may process the meal search request and send for display on the user computing devices a plurality of meals (See FIG. 8). The system 10 may include a meal share app that allows the user to sort or filter the meals displayed (See FIGS. 8 and 10). The sort filter may include, without limitation, genre of food, portion size, cost, location, time for pickup, cook rating and the like. This allows the user to parse through the meal data matching the criteria of the search request and then select the meal the user desires to eat. The system 10 may provide pick up location to the user computing device (See FIGS. 8 and 9).

The system 10 may include alerts to the user computing device 12 that inform the user of the timing of readiness of the meal, location of the meal pickup and the like. The cook may be notified through the meal share app operating on the cook computing device 13 that a user has selected the meal provided by the cook. The cook may then send information regarding the readiness of the meal being prepared and ordered by the user. The pickup location does not need to be location the meal is being prepared.

As part of the system, a cook that registered and signed up under the meal share system 10 may receive serving containers, wherein the serving containers have predetermined portion sizes (see FIGS. 5 and 6). These portion sizes may be varied depending on the type of food being prepared and shared. For example, soup may have a different container and portion than a lasagna. In each instance, the system 10 standardizes the portions sizes in order to provide predictable amounts of food that a user can expect to receive when placing an order for a meal using the system 10.

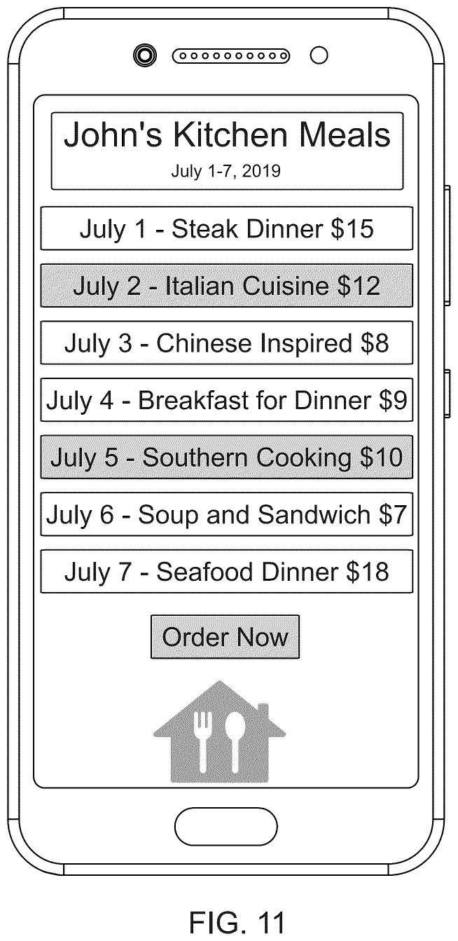

The system may include special event nights, such as but not limited to a certain type of food. FIG. 10 depicts a special event night for the preparation of paella dishes to be shared using the system 10. Another embodiment of the system 10 may include providing weekly meals, as depicted in FIG. 11, when a user likes a particular cook and looks up the meals that cook is preparing. The users may then see what meals are being prepared by that cook in a particular week.

Referring further to FIG. 11, the system 10 may include a subscription type service, wherein a user may subscribe to a particular cook's meals. The system 10 may display all of the meals each week, each month or the like. The list may provide the date, the meal and the cost or ordering each particular meal. In one embodiment, the user may receive all the meals in each week. In another embodiment, the user may select which meals he or she would like to order from the subscribed to cook.

Further still, embodiments of the system 10 may include a user that can purchase meal ingredients and have them shipped or otherwise provided to a particular cook or chef in the system to prepare the meal the user is wanting to eat.

Additionally, embodiments of the system may be paired with systems that rent vacation rentals or hotels, wherein the meal share system 10 can be offered to individuals using systems for renting vacation rentals or hotels in order to obtain a home cooked meal at the rental.

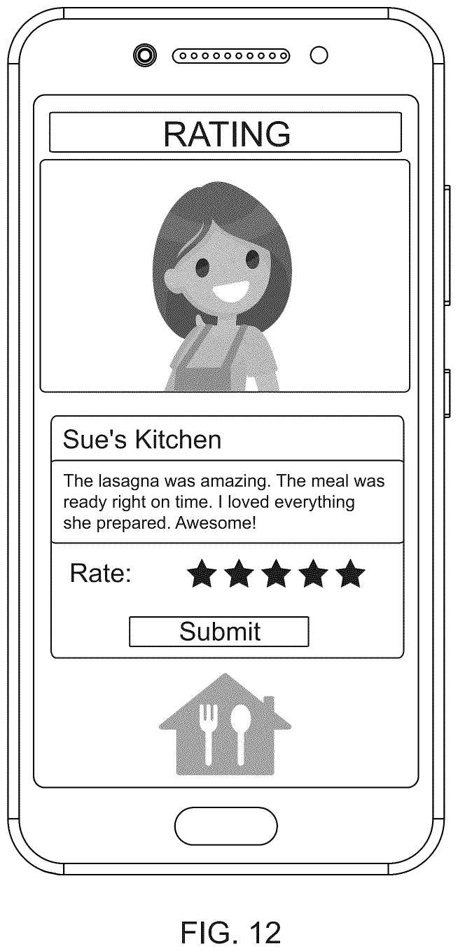

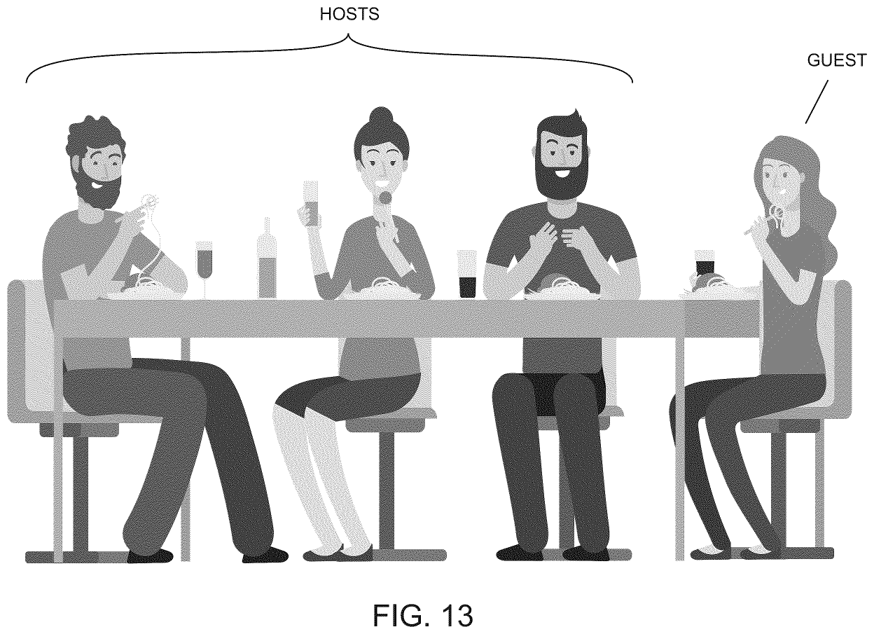

The system 10 may also allow for rating cooks. FIG. 12 depicts an interface that allows a user to rate a cook by giving a star rating and also commenting. The rating may be utilized by the system to sort meals that a user may want.

The system allows user who are lacking time or ability to prepare home cooked meals to obtain such meals. It further embodiments provide a meal sharing economy and empowers an individual at home with good cooking skills to make extra income from home doing what he or she is already skilled at and may enjoy sharing his or her home cooking.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, cloud-based infrastructure architecture, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A meal sharing system comprising:
a user computing device;
a cook computing device; and
a server having a memory, wherein the user computing device and the cook computing device are coupled to the server through a connection established by an app operating on each of the user computing device and the cook computing device, and wherein the server is programmed to:
receive a signal that includes meal data from the cook computing device, wherein the meal data includes cook information corresponding to a cook operating the cook computing device and meal information corresponding to a home-cooked meal;
automatically store the meal data in a memory of the server and make the meal data available for search and selection by a user operating the user computing device;
receive a signal that includes a search request information for a meal from the user computing device;
automatically process the search request information and send for display on the user computing device the meal data stored in the server, including the cook information and the meal information;
receive a signal that includes a meal selection from the user computing device and automatically process the meal selection;
send a notification to the cook computing device that the meal request is a request for a meal corresponding to the meal data sent to the system from the cook computing device; and
send an alert to the user computing device to inform the user of a timing of readiness of the meal and a location of pickup of the meal.

2. The meal sharing system of claim 1, wherein the server is further programmed to receive a signal that includes payment information from the user computing device, wherein the payment information includes stored payment system data of the user; automatically process the payment information; charge an electronic payment from the user; and send the electronic payment to an account designated by the cook.

3. The meal sharing system of claim 1, wherein the meal information includes ingredients for at least one dish forming a prepared meal.

4. The meal sharing system of claim 1, further comprising a plurality of uniformly-sized meal containers, wherein the cook may place the meal into one of the plurality of uniformly-sized meal containers.

5. The meal sharing system of claim 4, wherein each of the plurality of uniformly-sized meal containers is segmented.

6. The meal sharing system of claim 1, wherein the meal information includes a cost associated with the meal.

7. The meal sharing system of claim 1, wherein the cook information includes a rating of the cook, a review of the cook, or a rating and a review of the cook.

8. The meal sharing system of claim 1, wherein the server is further programmed to send for display on the user computing device a special event notification, wherein the special event notification includes a list of available meals for selection, wherein each available meal includes a common food type associated with the special event notification and has a corresponding pickup location located within a predetermined distance of the user computing device.

9. The meal sharing system of claim 1, comprising a plurality of cook computing devices.

10. The meal sharing system of claim 9, wherein the server is further programmed to send for display on the user computing device a list of meals for selection being prepared by one of a plurality of cooks operating a corresponding cook computing device of the plurality of cook computing devices, wherein each meal of the list of meals corresponds to a particular date.

11. The meal sharing system of claim 9, wherein the app includes a module for allowing the user to rate one of a plurality of cooks operating a corresponding cook computing device of the plurality of cook computing devices and post comments associated with the rated cook.

12. The meal sharing system of claim 11, wherein the server is further programmed to send a list of available meals, each of the list of available meals being associated with a cook of the plurality of cooks, wherein the list is sorted according to a rating of each corresponding cook.

13. The meal sharing system of claim 1, wherein the app includes a module that enables the user to communicate with the cook through the server, wherein the user may request from the cook a particular meal to be prepared by the cook and obtain delivery instructions for delivering ingredients to the cook for preparation of the requested meal.

14. The meal sharing system of claim 1, wherein the server is programmed to integrate with a property rental system, wherein the user may be an individual using the property rental system and accessing the meal sharing system through the property rental system.
